(19) United States
(12) Patent Application Publication
(10) Pub. No.: US 2026/0109196 A1
(43) Pub. Date: Apr. 23, 2026

(54) REFRIGERANT LOSS PROGNOSTIC STRATEGY FOR HEAT PUMPS OF VEHICLES

(71) Applicant: Ford Global Technologies, LLC, Dearborn, MI (US)

(72) Inventors: Tobias Bischoff, Pasadena, CA (US); Aaron James Vandiver, West Bloomfield, MI (US); Hao Song, Novi, MI (US); Andrew McKay, Farmington Hills, MI (US); Da Li, Sammamish, WA (US); Richard Johnston, Camano Island, WA (US); John Xiong, Holt, MI (US)

(73) Assignee: Ford Global Technologies, LLC, Dearborn, MI (US)

(21) Appl. No.: 18/924,448

(22) Filed: Oct. 23, 2024

(51) Int. Cl. B60H 1/32; B60H 1/00

(52) U.S. Cl. CPC B60H 1/3213; B60H 1/00885; B60H 1/32281

(57) ABSTRACT

A motor vehicle includes a heat pump with an expansion valve and a controller that is configured to control a position of the expansion valve based, at least in part, on a superheat target, and utilize differences between an expected position of the expansion valve and a controlled position of the expansion valve to estimate a refrigerant level of the heat pump and/or a remaining useful life of the heat pump. The controller is optionally configured to determine a plurality of estimated refrigerant levels during closed loop control of the heat pump system and utilize the plurality of estimated refrigerant levels to determine a trend in refrigerant level over time.

### FIELD OF THE DISCLOSURE

The present disclosure generally relates to a method of measuring refrigerant loss in a heat pump and/or predicting remaining useful life (RUL) of a heat pump system if the heat pump system is losing refrigerant.

### BACKGROUND OF THE DISCLOSURE

Various heat pump systems for motor vehicles have been developed. Heat pumps typically include a refrigerant loop that circulates refrigerant through a compressor, a condenser, an expansion valve, and a heat exchanger. A loss of refrigerant from the refrigerant loop may occur.

### SUMMARY OF THE DISCLOSURE

An aspect of the present disclosure is a method of monitoring refrigerant charge levels in a heat pump. The method includes initially operating the heat pump while measuring a plurality of operating parameters to provide initial measurements. During initial operation of the heat pump, an expansion valve is positioned in a feedforward position for a calibratable period of time. The feedforward position comprises a predefined position of the expansion valve that is predicted to provide a desired heat pump operation based, at least in part, on the initial measurements. The method further includes determining a plurality of calibrated feedforward positions based, at least in part, on the initial measurements. The heat pump is then operated utilizing a closed loop control that minimizes differences between a target superheat temperature and a measured superheat temperature utilizing a plurality of measured operational parameters. The method further includes estimating a refrigerant level based, on least in part, on differences between the positions of the expansion valve during closed loop control and the calibrated feed forward positions of the expansion valve.

Embodiments of the first aspect of the present disclosure can include any one or a combination of the following features:
The method may include repeatedly measuring the plurality of operating parameters while the heat pump system is operated utilizing closed loop control. It may also include repeatedly determining a difference between the closed loop control position of the expansion valve and a corresponding calibrated feedforward position, and determining if changes in the operating parameters over time indicate that the refrigerant level is decreasing.
The method may optionally include predicting a remaining useful life (RUL) of the heat pump utilizing changes in the expansion valve position and/or changes in the operating parameters over time.
The RUL may be based, at least in part, on predefined operating criteria defining acceptable heat pump operation.
The acceptable heat pump operating criteria may optionally comprise a predefined minimum refrigerant charge required for acceptable heat pump operation.
The predefined minimum refrigerant charge criteria optionally comprises a minimum refrigerant charge required for the heat pump to achieve target superheat temperatures during a plurality of predefined operating conditions.
The plurality of predefined operating conditions optionally comprise a plurality of likely operating conditions.
The method optionally includes generating an alert if the estimated refrigerant level is low according to predefined criteria.
The method optionally includes providing a user with the RUL estimate.
The method optionally includes alerting a user if the RUL is sufficiently short according to predefined criteria.
The plurality of measured operating parameters optionally comprises compressor speed, ambient temperature, a battery coolant temperature, and an operational mode.

Another aspect of the present disclosure is a heat pump system including a plurality of sensors that are configured to measure a plurality of operating parameters, a compressor, and a first coolant loop that circulates heated coolant that has been heated by a first heat exchanger, wherein the first heat exchanger is thermally coupled to heated refrigerant exiting the compressor. The pump system further includes an expansion valve that receives refrigerant from the first heat exchanger, and a second coolant loop that circulates coolant from the expansion valve. The heat pump system further includes a controller that is configured to: 1) initially operate the heat pump system while the expansion valve is at an initial feedforward position; 2) provide a plurality of adjusted feedforward positions that are determined, at least in part, on initial operating parameter measurements taken while the expansion valve is at the initial feedforward position; 3) operate the heat pump system utilizing closed loop control to minimize differences between a measured superheat and a target superheat by moving the position of the expansion valve to a plurality of controlled valve positions; 4) determining a plurality of adjusted feedforward positions at a plurality of times during closed loop control of the heat pump system utilizing a plurality of operating parameters measured during closed loop control of the heat pump system; 5) determining a plurality of differences between the adjusted feedforward positions and the corresponding controlled valve positions; and 6) estimating a refrigerant level of the heat pump system based, at least in part, on one or more of the plurality of differences.

Embodiments of the second aspect of the present disclosure can include any one or a combination of the following features:
The controller is optionally configured to: 1) determine a plurality of estimated refrigerant levels during closed loop control of the heat pump system; and 2) utilize the plurality of estimated refrigerant levels to determine a trend in refrigerant level over time.
The controller is optionally configured to predict a remaining useful life (RUL) based on the trend in refrigerant level over time.
The RUL prediction is optionally based, at least in part, on a minimum refrigerant charge required to provide predefined acceptable heat pump performance.
The controller is optionally configured to provide a communication to a user concerning at least one of an estimated refrigerant level and the RUL.
The plurality of measured operating parameters optionally comprises compressor speed, ambient temperature, a battery coolant temperature, and an operational mode.
A motor vehicle may include a heat pump system, and an electric drive including an electric motor and a high voltage (HV) battery, wherein at least one of the first and second coolant loops circulates coolant to heat and/or cool the HV battery.

Another aspect of the present disclosure is a motor vehicle including a heat pump system including an expansion valve and a controller that is configured to: 1) control a position of the expansion valve based, at least in part, on a superheat target; and 2) utilize differences between an expected position of the expansion valve required to meet the superheat target and a controlled position of the expansion valve to estimate a refrigerant level and/or a remaining useful life (RUL) and/or a remaining useful life (RUL) of the heat pump system.

Embodiments of the third aspect of the present disclosure can include the following feature:
The controller is optionally configured to: 1) determine a plurality of estimated refrigerant levels during closed loop control of the heat pump system; and 2) utilize the plurality of estimated refrigerant levels to determine a trend in refrigerant level over time.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a schematic view of a motor vehicle including a heat pump system according to an aspect of the present disclosure;

FIG. 2 is a schematic showing a refrigerant loop and a coolant loop;

FIG. 3 is a schematic of an expansion valve; and

FIG. 4 is a block diagram showing a refrigerant loss prognostic strategy according to an aspect of the present disclosure.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

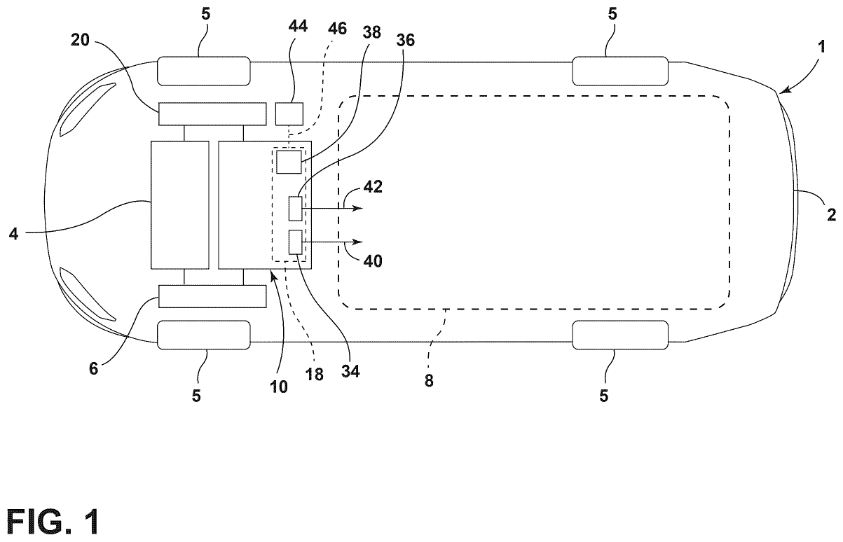

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a heat pump. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the terms “or” and “and/or,” when used in a list of two or more items, means that any one of the listed items can be employed by itself, or any combination of two or more of the listed items can be employed. For example, if a composition or device is described as containing or comprising components A, B, or C, the composition or device can contain (include) A alone; B alone; C alone; A and B in combination; A and C in combination; B and C in combination; or A, B, and C in combination. If a composition or device is described as containing or comprising components A and/or B and/or C, the composition or device can contain (include) A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” “including” or any other variation thereof, are intended to cover a non-exclusive inclusion, such that a process, method, article, or apparatus that includes or comprises a list of elements does not include only those elements but may include other elements not expressly listed or inherent to such process, method, article, or apparatus. An element preceded by “comprises . . . a” or “includes . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

The refrigerant loss prognostic strategy of the present application may be utilized in connection with various heat pump systems. For example, the prognostic strategy of the present application may be utilized in a heat pump refrigerant loop arrangement as disclosed in U.S. Patent Publication No. 2022/0412611, published on Dec. 29, 2022, the entire contents of which are incorporated herein.

With reference to FIG. 1, a vehicle 1 may include a body 2 and a powered drive system 4 that is operably connected to wheels 5 to provide for powered movement of vehicle 1. Vehicle 1 may include a battery or other voltage source 20 that may be operably connected to powered drive system 4. For example, if powered drive system 4 comprises one or more electric motors, the voltage source 20 may comprise a high voltage (HV) battery that supplies power to powered drive system 4. Vehicle 1 may optionally comprise a separate HV battery 44 that may be operably connected to voltage source 20. Powered drive system 4 may optionally comprise an internal combustion engine either by itself, or in combination with one or more electric motors. Body 2 may include a passenger space 8.

Vehicle 1 also includes a heat pump system 10 that may be configured to heat and/or cool passenger space 8. Vehicle 1 also includes a controller 6 that may be operably connected to the powered drive system 4, heat pump system 10, and/or other vehicle components (not shown). Controller 6 may comprise virtually any suitable controller or combination of controllers that may be operably interconnected to numerous sensors and actuators to control a wide range of vehicle components and systems.

As discussed in more detail below, heat pump system 10 may be configured to control one or more components of a vehicle thermal load 18. Vehicle thermal load 18 may include a heater core 34 that provides heated air 40 to passenger compartment 8, and a cooler core 36 that provides cooled air 42 to passenger compartment 8. Thermal load 18 may also include a battery heat exchanger 38 that is configured to control a temperature of high voltage (HV) battery 44 (e.g. if power drive system 4 includes one or more electric motors that are supplied with power from an HV battery 44).

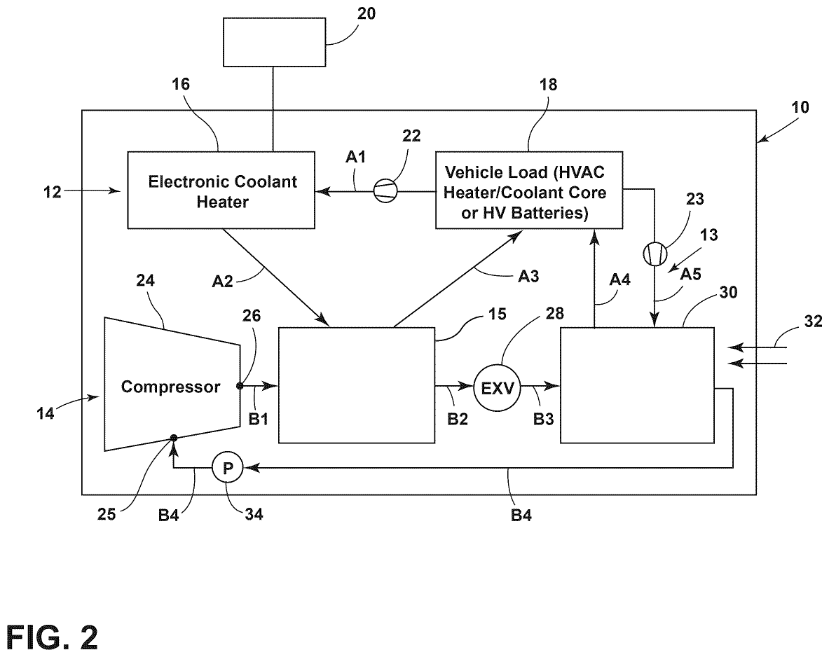

With further reference to FIG. 2, heat pump system 10 may include a compressor 24, a first heat exchanger 15, an expansion valve 28, and a second heat exchanger 30. Compressor 24 compresses refrigerant whereby the compressed refrigerant flows from outlet 26 of compressor 24 to the first heat exchanger 15 as shown by the arrow “B1.” After the refrigerant flows through the first heat exchanger 15, the refrigerant flows to expansion valve 28 as shown by the arrow “B2,” and the refrigerant then flows to second heat exchanger 30 as shown by the arrow “B3.” Air 32 may flow over second heat exchanger 30 if required for a particular application. The refrigerant then flows from second heat exchanger 30 to inlet 25 of compressor 24 as shown by the arrow “B4.”

The heat pump system 10 may include a first coolant loop 12 whereby liquid coolant that is heated by first heat exchanger 15 flows to a vehicle thermal load 18 as shown by the arrow A3. The first coolant loop 12 may optionally include an electronic coolant heater 16 that may be operably connected to voltage source 20 to further heat coolant in first coolant loop 12 if required. First coolant loop 12 may include a pump 22 that circulates the fluid through the first heat exchanger 15, thermal load 18, and heater 16 as shown by the arrows “A1,” “A2,” and “A3.”

The heat pump system 10 may include a second coolant loop 13 having a pump 23 that circulates liquid coolant from second heat exchanger 30 to vehicle load 18 as shown by the arrow “A4,” and returns liquid coolant to the second heat exchanger 30 as shown by the arrow “A5.” Liquid coolant flowing in the second coolant loop 13 is cooled by the second heat exchanger 30 to cool the vehicle load 18 if necessary.

Thus, the first coolant loop 12 can be utilized to heat one or more components of vehicle load 18 if necessary, and the second coolant loop 13 can be utilized to cool one or more components of the vehicle thermal load 18. It will be understood that the flow of coolant in the first and second coolant loops 12 and 13 can be controlled whereby a heater core of a passenger compartment heater can be heated utilizing first coolant loop 12 while an HV battery is simultaneously cooled utilizing second coolant loop 13.

Referring again to FIG. 1, vehicle thermal load 18 may include a heater core 34 and a cooler core 36. Heater core 34 may be supplied with heated coolant from first coolant loop 12 to heat air 40 that is directed to passenger space 8, and cooler core 36 may be operably connected to second coolant loop 13 to cool air 42 that is directed into passenger space 8. It will be understood that the air may be initially cooled by cooler core 36, then heated by heater core 34 to reduce a moisture content of the air.

Referring again to FIG. 1, battery heat exchanger 38 may be operably connected to first and second coolant loops 12 and 13 whereby the battery heat exchanger 38 is configured to control a temperature of high voltage (“HV”) battery 44. The battery heat exchanger 38 may be thermally coupled to the HV battery 44 as shown schematically by the dashed line 46. Thermal coupling 46 may comprise suitable heat conductive materials.

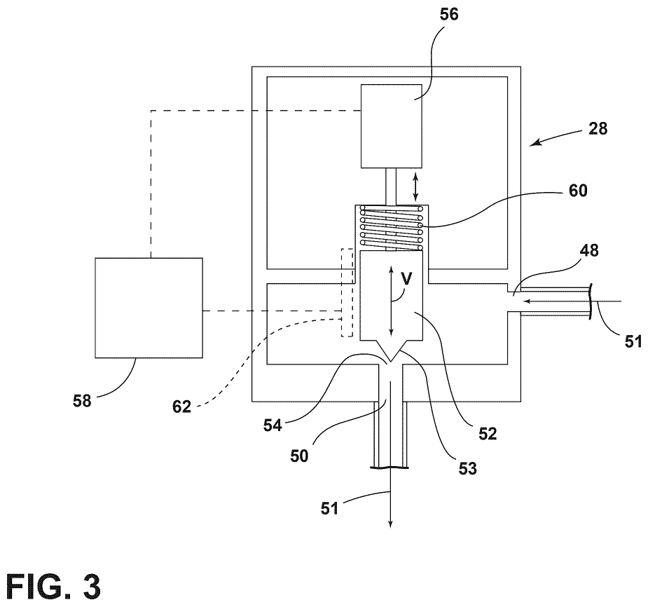

With further reference to FIG. 3, expansion valve 28 may include an inlet 48 that receives refrigerant 51 and an outlet 50 at which refrigerant 51 exits the valve 28. A valve member 52 includes a tapered (e.g. conical) valve surface 53 that is biased into engagement with an opening 54 by a resilient member such as spring 60. A powered actuator 56 may be operably connected to a controller 58 to thereby shift the valve member 52 upwardly and/or downwardly in the direction of the arrow “V” as required to control a position of valve member 52. Powered actuator 56 may comprise a two-way actuator such that spring 60 is not required. A sensor 62 determines a position of valve member 52. Controller 58 may be operably connected to sensor 52. Thus, a position of valve member 52 can be controlled to provide a desired flow of refrigerant through the valve 28, and the position of valve member 52 of valve 28 can be measured. Controller 58 may comprise part of controller 6 (FIG. 1) of vehicle 1. It will be understood that FIG. 3 is schematic in nature, and virtually any suitable control valve configuration may be utilized in accordance with the present disclosure.

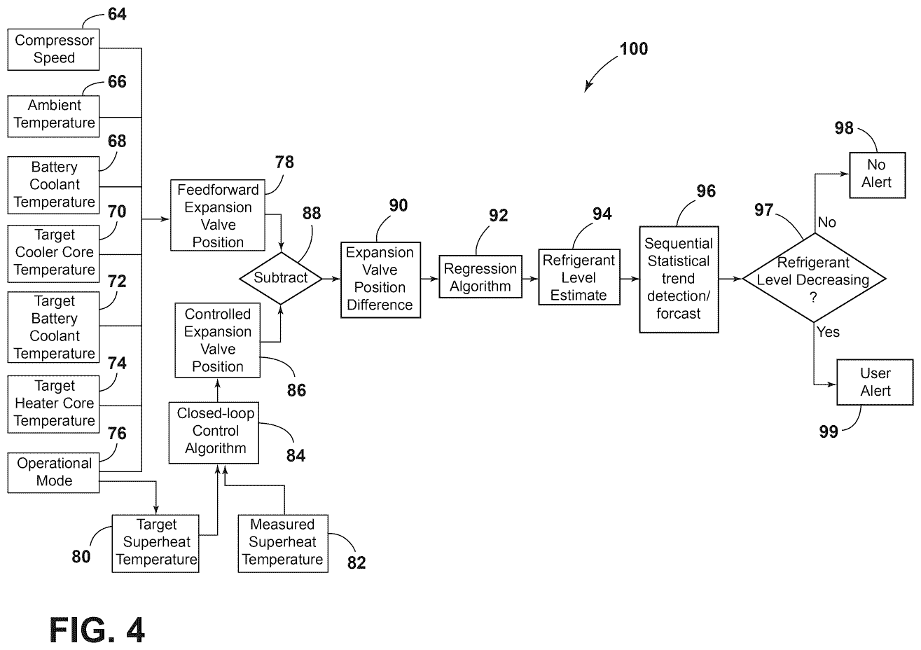

With further reference to FIG. 4, a refrigerant loss prognostic strategy or method 100 according to an aspect of the present disclosure includes utilizing differences in an expansion valve position (e.g. position of valve member 52 of valve 28) to determine if a refrigerant level in the system 10 has dropped and/or to predict future reductions in refrigerant level. Control system 6 may be configured to utilize one or more measured operating parameters such as compressor speed 64, ambient temperature 66, battery coolant temperature 68, target cooler core temperature 70, target battery coolant temperature 72, target heater core temperature 74 and operational mode 76 to determine a target superheat temperature 80.

Compressor speed 64 may comprise a measured RPM of compressor 24. Ambient temperature 66 may be determined utilizing an onboard temperature sensor of vehicle 1. Battery coolant temperature 68 may comprise a measured temperature of liquid coolant flowing through battery heat exchanger 38. For example, the temperature of coolant entering and/or exiting battery heat exchanger 38 may be measured utilizing one or more temperature sensors.

Target cooler core temperature 70 may comprise a desired temperature for cooler core 36 that is required to provide cool air 42 (FIG. 1) as required to cool passenger space 8 based on user inputs, ambient temperature, and/or other variables. Target battery coolant temperature 72 may comprise a target temperature for coolant entering and/or exiting battery heat exchanger 38 as required to maintain a desired battery temperature. Target heater core temperature 74 may comprise a desired temperature of coolant entering and/or exiting heater core 34. Target heater core temperature 74 may be determined, based at least in part, on a volume and/or temperature of heated air 40 required to heat passenger space 8.

Operational mode 76 may comprise a user input such as a request to heat or cool passenger space 8.

In addition to target superheat 80, the system also utilizes measured superheat 82. Measured superheat 82 may be calculated using pressure and/or temperature measurements from sensors located downstream of second heat exchanger 30 and the properties of the refrigerant being used in the refrigerant loop 14. It will be understood that the heat pump system 10 may include a plurality of heat exchangers (“chillers”) that receive refrigerant from one or more expansion valves, and the measured superheat 82 may be calculated utilizing pressure and temperature measurements from a plurality of sensors located downstream of each chiller as required for a particular application. Also, it will be understood that various methods may be utilized to measure/estimate/calculate superheat, and the present disclosure is not limited to the specific examples provided herein.

Target superheat 80 and measured superheat 82 are input to a close-loop control algorithm 84 to control a position of expansion valve 28 as shown at step 86. Control algorithm 84 may comprise, for example, a PID control algorithm that is configured to minimize a difference between a target superheat temperature 80 and a measured superheat temperature 82. However, the present disclosure is not limited to any specific control algorithm, and virtually any suitable control may be utilized to control a position of expansion valve 86.

At steps 88 and 90, a difference between feedforward expansion valve position 78 and controlled expansion valve position 86 is determined utilizing subtraction at step 88. A regression algorithm 92 is then utilized to estimate refrigerant level at step 94. At step 96, a sequential statistical trend may be detected and/or forecasted, and this may be utilized to determine if a refrigerant level is decreasing at step 97. If the refrigerant level is not decreasing no alert is provided as shown at step 98. However, if the refrigerant level is decreasing at step 97, a user alert is generated as shown at step 99.

Referring again to FIG. 4, the strategy or method 100 may involve calibrating base superheat targets and comparing them with calculated refrigerant superheat values from pressure and temperature sensor measurements at one or more heat exchangers as shown at steps 78, 86, 88, and 90. To control the superheat values at the measurement sites, expansion valve 28 operates between calibratable minimum and maximum positions in closed loop control (step 84), and expansion valve 28 is set to calibratable specific values when inactive. When the expansion valve 28 is in an active position, the PID controller 84 first moves the expansion valve into a feedforward position for a calibratable amount of time, after which the full PID controller is active in a closed-loop control manner. The PID control input may be based on an error between the target and measured superheat with expansion valve feedforward positions adjusted according to operational mode, ambient temperature, battery coolant temperature, target battery coolant temperature, target heater core temperature, target cooler core temperature, and compressor speed, among other potential data streams. Thus, the feedforward position of the expansion valve (step 78) is based on various operational and ambient variables.

The process may include recording actual expansion valve positions and computing the differences relative to the initial feedforward positions. These values may vary as the PID controller keeps the superheat value at or near the target superheat temperature for different operational modes (e.g., battery cooling, cabin heating, etc.). Conditional on the operational mode of the system 10, the difference between target and measured superheat typically fluctuates around a steady state. However, if this difference steadily increases over time, this may indicate that the refrigerant level in the system 10 is falling because the PID controller must open the expansion valve 28 further than expected for a fully charged system in order to meet the superheat target.

The time history of the measured expansion valve position may be utilized to predict the future position of the expansion valve 28 (e.g., utilizing probabilistic time series modeling), or to detect a change in the trend via sequential detection strategies (e.g. cumulative sum control chart (CUSM) detectors). Because the opening position of the expansion valve 28 compared to the calibrated feedforward positions are statistically related to the refrigerant level in the system 10 even under changing load requirements, the measured expansion valve position can be utilized to predict the future level of refrigerant in the system 10, and/or to detect trends in the refrigerant level. This permits prediction and/or detection of a point at which there is insufficient or decreasing refrigerant in the system. This in turn permits the system 10 to alert the user/owner and schedule maintenance before the problem impacts the operation of system 10 and/or vehicle 1.

The feedforward expansion valve position 78 (FIG. 4) is an expected valve position that may be based on various parameters, including heat pump operating state (cabin heating, cabin cooling, cabin and/or battery cooling, dehumidifying, etc.), environmental state (e.g. ambient temperature, battery coolant temperature, etc.), expected heat pump load (cooler core target temperature, heater core target temperature, battery coolant target temperature, compressor speed, etc.), and target superheat which is calibratable based on ideal operating conditions based on the use case balance between performance and efficiency. The feedforward valve positions may be developed for different vehicle applications based on expected “normal” operating condition in each of the parameters, and serve as a starting position for the expansion valve 28 before entering the closed loop control state (step 84).

The closed loop control then makes minor adjustments to the position of expansion valve 28 to maintain the target superheat based on deviation from normal. This deviation may be caused by, for example, user deviations from “normal” use such as manually adjusting the blower speed of the cabin heating and cooling fan, or changes in environmental conditions such as a strong head or tail wind impacting air flow.

The feedforward expansion valve position 78 may comprise an expected valve position that may take into account numerous operating parameters. In general, the operating parameters may be selected and measured such that differences between the feedforward (expected) valve position 78 and the valve position 86 determined by the closed loop control 84 is solely or primarily due to changes in the refrigerant level in the refrigerant loop 14 of heat pump system 10.

In a simplified example, a user drives vehicle 1 the same distance every day for a week (e.g. during the summer). During the week, in the example, the weather stays consistent, and the user does not change the climate control setting for passenger space 8 during the drive. In this example, on day 1, the heat pump control 84 sets the feedforward position 78 to 40% valve opening and the superheat target to 7 degrees Kelvin. Due to changing conditions during the drive the expansion valve 28 may move between 37%-43% open to maintain the target superheat 80 on day 1.

In this example, there is a refrigerant leak in the heat pump system 10 of vehicle 1 which reduces the available refrigerant. However, the heat exchanger capacity is fixed. Thus, as mass flow decreases due to loss of refrigerant, the valve opening position must continue to increase to maintain the 7 degrees Kelvin superheat target (i.e. the closed loop control 84 increases the valve position 86 to meet the superheat target). In this example, over the next 6 days the expansion valve position 86 and superheat are the following:
Day 2: 40%-46%, 7 degrees Kelvin
Day 3: 46%-52%, 7 degrees Kelvin
Day 4: 55%-60%, 7 degrees Kelvin
Day 5: 70%-75%, 7 degrees Kelvin
Day 6: 75%, 9 degrees Kelvin
Day 7: 75%, 12 degrees Kelvin

The increasing expansion valve position 86 is a result of the reductions in refrigerant. In this example, 75% is the maximum possible the expandable valve can be opened, and the system is not able to achieve the 7 degrees Kelvin target superheat on days 6 and 7 due to loss of refrigerant. If there was another issue impacting performance other than a refrigerant leak (e.g. leaves blocking the grill), this may result in a one-time increase in expansion valve position, but it would be stable rather than trending upward.

Once expansion valve 28 reaches its maximum opening position, the ability to maintain the superheat target is lost, and the loss of refrigerant impacts the system performance.

Various approaches may be utilized to estimate the remaining useful life (RUL) of the heat pump 10. The RUL may correspond to a predefined criteria. For example, the RUL may comprise an estimate of the time until the system 10 is no longer able to maintain a superheat target due to loss of refrigerant. The criteria may comprise, for example, a “worst case” scenario in which the vehicle operating parameters combine to make it more difficult for the system 10 to achieve the superheat target. For example, if vehicle 1 is designed to operate in 120° F. ambient conditions while a user sets the passenger space 8 climate control at 60°, and the drive system 4 is at a maximum demand on HV battery 44, this combination of operating parameters may represent a maximum cooling demand on heat pump 10. Thus, the RUL estimate may comprise a time at which the system 10 is predicted to no longer be able to maintain a superheat target under these operating conditions. However, the remaining useful life may comprise other criteria (e.g. a loss of refrigerant causing a loss of efficiency) that predicted to occur prior to an inability to maintain the superheat target.

Various approaches may be utilized to estimate RUL. These include, for example, the survival model, the degradation model, or the similarity model.

The survival model estimates RUL based solely on component failure time data, which can be obtained from lab testing, repair records, or other empirical data. Using this data, a probability density function (PDF) is constructed to represent the distribution of failure times from a population. The expected value of the PDF corresponds to the total useful life of the component. Subtracting the current operating time from the total useful life yields the RUL.

In a compact mathematical form:

$$RUL = \frac{1}{R ( {t}_{0} )} {\int }_{{t}_{0}}^{∞} R ( t ) dt$$

Where:
   R(t) is the Reliability function which can be modeled using a Weibull distribution.
   t₀ is the current operating time.

The RUL estimate obtained from the survival model represents the expected lifetime for the entire population of components. The estimate is not tailored to each specific component, and the estimate does not take into account the unique degradation curve of the component (e.g. refrigerant charge) of interest. As a result, it may not provide the most accurate RUL estimate, and a similarity model may be utilized to obtain a more accurate estimate.

The degradation model may be used when failure time data is not available (e.g. the components are newly introduced, and few failures have occurred), but a threshold (limit) is known. In this case, a degradation model may be fit to the condition indicator using the degradation data from the component to predict how the condition indicator will change in the future. It is possible to statistically estimate how much time there will be until the condition indicator crosses the threshold. The uncertainties in degradation tend to increase over time, which in turn tends to widen the confidence interval of the model.

Utilizing the degradation model offers a degree of customized RUL prediction for a specific component, but it may not be as finely tailored as the similarity model, which typically requires higher resolution data on run-to-failure history from the population.

If complete run-to-failure histories from the population is available, including data on the healthy state, degradation, and failure time, the similarity model can be used to estimate RUL. This method compares the degradation curve of the component to the degradation curves of similar components with known failure times. By identifying the most similar components, the similarity model can estimate the RUL of the component of interest (similar to the survival model, but only using the similar components).

This approach begins by performing data reduction to identify trendable data (as some sensor data may not reflect degradation) and then combine the trendable data to compute condition indicators. Next, a similarity model may be trained using run-to-failure trajectories of the population. By identifying the closest N profiles to the current component, the RUL can be estimated using the failure time of those closest neighbors. To evaluate the prediction error, a train-test split can be performed at this stage. The EUL prediction may be continuously updated as the closest profiles change over time. This method may provide the most tailored and accurate prediction of RUL.

In general, the RUL estimate or forecast 96 (FIG. 4) may combine one or more of the survival model, degradation model, and/or similarity model. The survival model, degradation model, and similarity model are generally known, such that a more detailed description is not believed to be required. Nevertheless, it will be understood that these are merely examples of RUL prediction models, and the present disclosure is not limited to these examples.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A method of monitoring refrigerant charge levels in a heat pump, the method comprising:
initially operating the heat pump while measuring a plurality of operating parameters to provide initial measurements;
during initial operation of the heat pump, positioning an expansion valve of the heat pump in a feedforward position for a calibratable period of time, wherein the feedforward position comprises a predefined position of the expansion valve that is predicted to provide a desired heat pump operation based, at least in part, on the initial measurements;
determining a plurality of calibrated feedforward positions based, at least in part, on the initial measurements;
followed by operating the heat pump utilizing a closed loop control that minimizes differences between a target superheat temperature and a measured superheat temperature utilizing a plurality of measured operating parameters; and
estimating a refrigerant level based, on least in part, on differences between the positions of the expansion valve during closed loop control and the calibrated feed forward positions of the expansion valve.

2. The method of claim 1, including:
repeatedly measuring the plurality of operating parameters while the heat pump system is operated utilizing closed loop control;
repeatedly determining a difference between the closed loop control position of the expansion valve and a corresponding calibrated feedforward position; and
determining if changes in the operating parameters over time indicate that the refrigerant level is decreasing.

3. The method of claim 2, including:
predicting a remaining useful life (RUL) of the heat pump utilizing changes in the expansion valve position and/or changes in the operating parameters over time.

4. The method of claim 3, wherein:
the RUL is based, at least in part, on predefined criteria defining acceptable heat pump operation.

5. The method of claim 4, wherein:
the acceptable heat pump operating criteria comprises a predefined minimum refrigerant charge required for acceptable heat pump operation.

6. The method of claim 5, wherein:
the predefined minimum refrigerant charge criteria comprises a minimum refrigerant charge required for the heat pump to achieve target superheat temperatures during a plurality of predefined operating conditions.

7. The method of claim 6, wherein:
the plurality of predefined operating conditions comprise a plurality of likely operating conditions.

8. The method of claim 1, including:
generating an alert if the estimated refrigerant level is low according to predefined criteria.

9. The method of claim 3, including:
providing a user with the RUL estimate.

10. The method of claim 3, including:
alerting a user if the RUL is sufficiently short according to predefined criteria.

11. The method of claim 1, wherein:
the plurality of measured operating parameters comprises compressor speed, ambient temperature, a battery coolant temperature, and an operational mode.

12. A heat pump system comprising:
a plurality of sensors configured to measure a plurality of operating parameters;
a compressor;
a first coolant loop that circulates heated coolant that has been heated by a first heat exchanger, wherein the first heat exchanger is thermally coupled to heated refrigerant exiting the compressor;
an expansion valve that receives refrigerant from the first heat exchanger;
a second coolant loop that circulates coolant from the expansion valve;
a controller that is configured to:
initially operate the heat pump system while the expansion valve is at an initial feedforward position;
provide a plurality of adjusted feedforward positions that are determined, at least in part, on initial operating parameter measurements taken while the expansion valve is at the initial feedforward position;
operate the heat pump system utilizing closed loop control to minimize differences between a measured superheat and a target superheat by moving the position of the expansion valve to a plurality of controlled valve positions;
determining a plurality of adjusted feedforward positions at a plurality of times during closed loop control of the heat pump system utilizing a plurality of operating parameters measured during closed loop control of the heat pump system;
determining a plurality of differences between the adjusted feedforward positions and the corresponding controlled valve positions; and
estimating a refrigerant level and/or a remaining useful life (RUL) of the heat pump system based, at least in part, on one or more of the plurality of differences.

13. The heat pump system of claim 12, wherein:
the controller is configured to: 1) determine a plurality of estimated refrigerant levels during closed loop control of the heat pump system; and 2) utilize the plurality of estimated refrigerant levels to determine a trend in refrigerant level over time.

14. The heat pump system of claim 13, wherein:
the controller is configured to predict a remaining useful life (RUL) based on the trend in refrigerant level over time.

15. The heat pump system of claim 14, wherein:
the RUL prediction is based, at least in part, on a minimum refrigerant charge required to provide predefined acceptable heat pump performance.

16. The heat pump system of claim 14, wherein:
the controller is configured to provide a communication to a user concerning at least one of an estimated refrigerant level and the RUL.

17. The heat pump system of claim 12, wherein:
the plurality of measured operating parameters comprises compressor speed, ambient temperature, a battery coolant temperature, and an operational mode.

18. A motor vehicle comprising the heat pump system of claim 16, and including:
an electric drive including an electric motor and a high voltage (HV) battery; and wherein:
at least one of the first and second coolant loops circulates coolant to heat and/or cool the HV battery.

19. A motor vehicle comprising:
a heat pump system including an expansion valve and a controller that is configured to:
control a position of the expansion valve based, at least in part, on a superheat target; and
utilize differences between an expected position of the expansion valve that is predicted to meet the superheat target and a controlled position of the expansion valve to estimate a refrigerant level and/or predict a remaining useful life (RUL) of the heat pump system.

20. The motor vehicle of claim 19, wherein:
the controller is configured to determine a plurality of differences between expected position of the expansion valve and controlled position of the expansion valve over time, and determine at least one predicted future refrigerant level based on one or more trends in the differences between expected position of the expansion valve and controller position of the expansion valve over time.
